(19) United States
(12) Patent Application Publication
(10) Pub. No.: US 2012/0270535 A1
(43) Pub. Date: Oct. 25, 2012

(54) Implicit CSI Feedback for DL Multiuser MIMO Transmission

(75) Inventors: Runhua Chen, Plano, TX (US); Eko N. Onggosanusi, Allen, TX (US)

(73) Assignee: TEXAS INSTRUMENTS INCORPORATED, Dallas, TX (US)

(21) Appl. No.: 12/969,165

(22) Filed: Dec. 15, 2010

Related U.S. Application Data
(60) Provisional application No. 61/287,436, filed on Dec. 17, 2009.

(51) Int. Cl. H04W 24/10

(52) U.S. Cl. 455/422.1

(57) ABSTRACT

This invention is method of implicit channel state information (CSI) feedback for multiuser multiple input, multiple output (MU-MIMO) communication between a base station (eNB) and a plurality of user equipment (UE). Each user equipment reporting a plurality of single user precoding matrix indicators (PMI) including a first PMI indicating a recommended optimum precoding matrix and at least one further PMI indicating information for beamforming at said base station. The base station communicates with each user equipment based on precoding matrix indicators received from the plurality of user equipment.

### CLAIM OF PRIORITY

This application claims priority under 35 U.S.C. 119(e)(1) to U.S. Provisional Application No. 61/287,436 filed Dec. 17, 2009.

### TECHNICAL FIELD OF THE INVENTION

The technical field of this invention is wireless telephony.

### BACKGROUND OF THE INVENTION

A Downlink Multiuser, Multiple Input, Multiple Output (DL MU-MIMO) communication system involves a single Evolved Universal Terrestrial Radio Access Node B (eNB) transmitting to multiple user equipment (UE) at the same time over the same frequency band. One example DL MU-MIMO technique is called the dirty-paper coding approach. This dirty-paper technique is the optimal MU-MIMO scheme for achieving the maximum sum capacity from the information theory perspective. An alternative and more practical MU-MIMO scheme is transmit precoding. In transmit precoding the data to each UEs is multiplied with a UE-specific precoding matrix and then transmitted at the eNB antenna array simultaneously.

The Third Generation Partnership Project (3GPP) Evolved Universal Terrestrial Radio Access (E-UTRA) Long Term Evolution (LTE) Rel-8 specification supports a very simple MU-MIMO technique. A dedicated MU-MIMO mode is configured so that a UE knows that the eNB attempts to schedule it with one or more other UEs. Codebook-based precoding enables selection of the precoding matrices for a UE from a pre-defined set (codebook) of fixed precoding matrices/vectors. Channel Quality Indicator (CQI) feedback reports the DL channel status to the eNB in order to perform accurate DL link adaptation, such as rank, precoding matrices, modulation and coding schemes, frequency-selective scheduling, and UE scheduling. Upon CQI feedback a UE does not know which other UEs it will be scheduled together nor what precoding matrices will be used for the co-schedule UE, hence CQI report from one UE does not accurately account for the actual interference received on data transmission. CQI feedback in E-UTRA LTE Rel-8 is based on single user (SU) MIMO precoding. This constraint causes the CQI report for MU-MIMO mode in E-UTRA LTE Rel-8 to be highly unreliable. This limits the performance of E-UTRA LTE Rel-8 MU-MIMO.

Thus there is a need in the art for efficient transmission of channel state information (CSI) feedback for MU-MIMO to support link adaptation and scheduling procedure.

### SUMMARY OF THE INVENTION

This invention is method of implicit channel state information (CSI) feedback for multiuser multiple input, multiple output (MU-MIMO) communication between a base station (eNB) and a plurality of user equipment (UE). Each user equipment reporting a plurality of single user precoding matrix indicators (PMI) including a first PMI indicating an recommended optimum precoding matrix and at least one further PMI indicating information for beamforming at said base station. The base station communicates with each user equipment based on precoding matrix indicators received from the plurality of user equipment.

### BRIEF DESCRIPTION OF THE DRAWINGS

These and other aspects of this invention are illustrated in the drawings, in which:

FIG. 1 illustrates an exemplary prior art wireless communication system to which this application is applicable;

FIG. 2 shows the Evolved Universal Terrestrial Radio Access (E-UTRA) Time Division Duplex (TDD) frame structure of the prior art;

FIG. 3 illustrates an example where the reporting periodicity of multiple user multiple input, multiple output (MU-MIMO) channel state information feedback is an integer times of that the single user multiple input, multiple output (SU-MIMO) channel state information feedback reporting periodicity;

FIG. 4 illustrates an example of when single user multiple input, multiple output channel state information feedback and multiple user multiple input, multiple output channel state information feedback are reported in the same subframe;

FIG. 5 illustrates an example when single user multiple input, multiple output channel state information feedback and multiple user multiple input, multiple output channel state information feedback occur in different subframes in a time-division multiplexing (TDM) manner;

FIG. 6 illustrates an example where one uplink grant triggers both multiple user multiple input, multiple output channel state information feedback and single user multiple input, multiple output channel state information feedback;

FIG. 7 illustrates an example where an uplink grant includes a 1-bit flag requesting single user multiple input, multiple output channel state information feedback;

FIG. 8 illustrates an example where an uplink grant includes a 1-bit flag requesting multiple user multiple input, multiple output channel state information feedback; and

FIG. 9 is a block diagram illustrating internal details of a base station and a mobile user equipment in the network system of FIG. 1 suitable for implementing this invention.

### DETAILED DESCRIPTION OF PREFERRED EMBODIMENTS

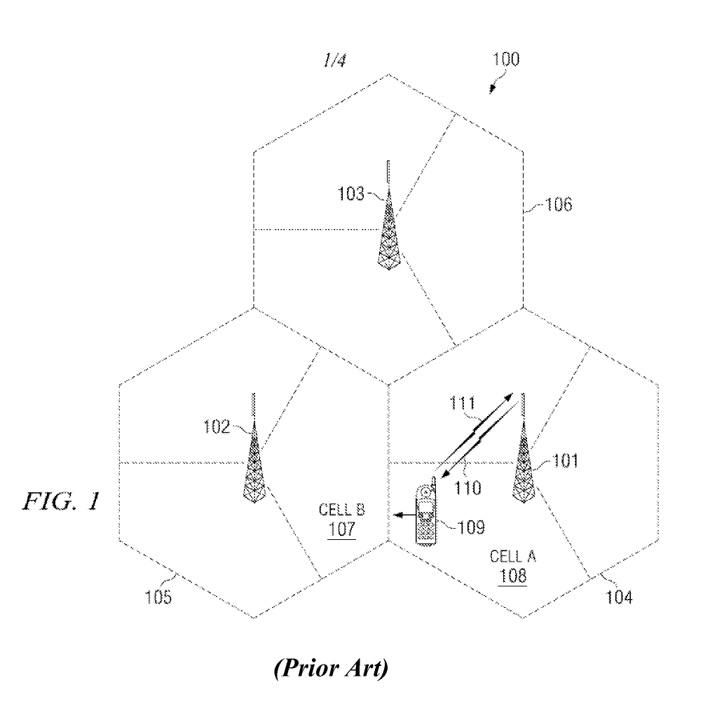

FIG. 1 shows an exemplary wireless telecommunications network 100. The illustrative telecommunications network includes base stations 101, 102 and 103, though in operation, a telecommunications network necessarily includes many more base stations. Each of base stations 101, 102 and 103 (eNB) are operable over corresponding coverage areas 104, 105 and 106. Each base station's coverage area is further divided into cells. In the illustrated network, each base station's coverage area is divided into three cells. Handset or other user equipment (UE) 109 is shown in Cell A 108. Cell A 108 is within coverage area 104 of base station 101. Base station 101 transmits to and receives transmissions from UE 109. As UE 109 moves out of Cell A 108 and into Cell B 107, UE 109 may be handed over to base station 102. Because UE 109 is synchronized with base station 101, UE 109 can employ non-synchronized random access to initiate handover to base station 102.

Non-synchronized UE 109 also employs non-synchronous random access to request allocation of up-link 111 time or frequency or code resources. If UE 109 has data ready for transmission, which may be traffic data, measurements report, tracking area update, UE 109 can transmit a random access signal on up-link 111. The random access signal notifies base station 101 that UE 109 requires up-link resources to transmit the UEs data. Base station 101 responds by transmitting to UE 109 via down-link 110, a message containing the parameters of the resources allocated for UE 109 up-link transmission along with a possible timing error correction. After receiving the resource allocation and a possible timing advance message transmitted on down-link 110 by base station 101, UE 109 optionally adjusts its transmit timing and transmits the data on up-link 111 employing the allotted resources during the prescribed time interval.

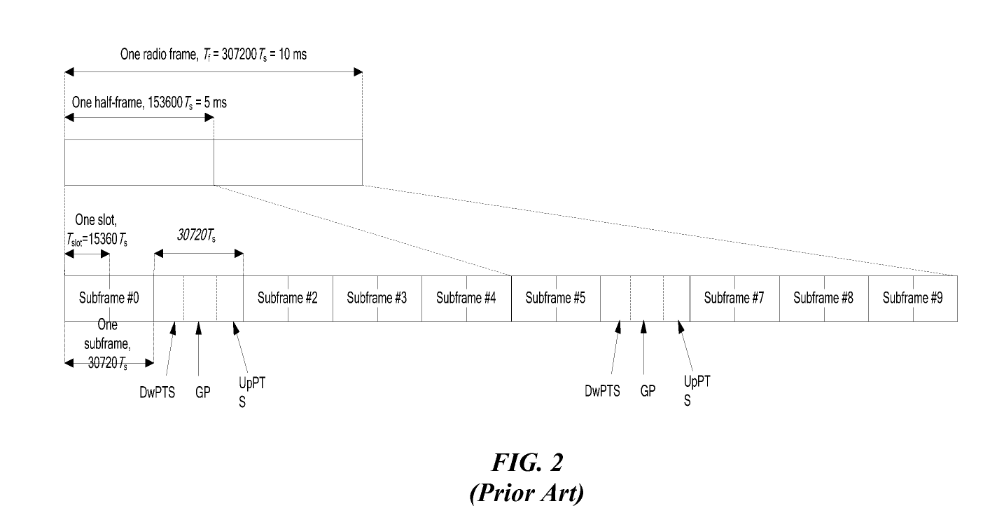

FIG. 2 shows the Evolved Universal Terrestrial Radio Access (E-UTRA) time division duplex (TDD) Frame Structure. Different subframes are allocated for downlink (DL) or uplink (UL) transmissions. Table 1 shows applicable DL/UL subframe allocations.

TABLE 1

| Con- | Switch-point | Sub-frame number | | | | | | | | | |
|---|---|---|---|---|---|---|---|---|---|---|---|
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

Sounding RS enables time and frequency domain scheduling and has been adopted as a RAN1 working assumption for E-UTRA. The channel quality indicator (CQI) estimate obtained from sounding can be expired or stale because of the inevitable time delay between channel sounding and the follow-up scheduled transmission. This is more pronounced for faster user equipment (UE). Thus faster UE needs to have more frequent sounding in order to maintain the fresh CQI at eNB 101. For example a UE with a Doppler of 200 Hz requires a propagation channel for every fifth sub-frame because the sub-frame rate is 1000 Hz. In such case for channel adaptive modulation and coding (AMC) to be performed, UE 109 must sound nearly every sub-frame or every other sub-frame. The objective of maintaining a fresh CQI at eNB 101 may be impossible for very fast UEs having a Doppler of 200 Hz or more because the channel can change substantially between sub-frames. For such fast UEs, a slow rate of infrequent sounding can be performed. Slower UEs naturally ought to sound less frequently. As UE 109 speed increases, the sounding period should reduce up to a point. Very fast UEs should abandon the goal of maintaining a fresh CQI and sound less frequently.

A simple solution is to configure each cell with a common sounding period for each UE and for each sounding resource. However, any cell may contain UEs with a spread of velocities yielding a spread of Dopplers. Allocating sounding resources to UEs corresponding to the set of UEs velocities would be efficient. This allocation enables efficient utilization of sounding resources. In another proposed allocation, very slow UEs sound only once per several sub-frames and intermediate speed UEs sound once per few sub-frames. This allocation is not straight forward and not always possible. It is mathematically impossible to share a common sounding resource between one UE sounding every 2 sub-frames and a second UE sounding every 3 sub-frames. There is a need in the art to use different sounding periods for different cells while tailoring each sounding period to the velocity of a UE or subset of UEs.

With spatial multiplexing, an Evolved Universal Terrestrial Radio Access Node B base station (eNB) may send multiple data streams (or layers) to UEs in downlink transmissions using the same frequency band. The number of such layers or streams is defined as the rank. For E-UTRA LTE Rel-8, a UE needs to estimate the DL channel and report the recommended rank indicator (RI) to eNB 101. The UE also must report the channel quality indicator (CQI) and the precoding matrix indicator (PMI), which is an index to the precoding matrix in a codebook. These indicators form a set of recommended transmission properties to eNB 101. Upon receiving this feedback from each UE (RI/PMI/CQI), eNB 101 performs corresponding downlink MIMO transmission scheduling.

Implicit CSI (CQI/PMI/RI) feedback is based on a pre-defined set of codebooks. These pre-defined set of codebooks are a set of matrices calculated offline and known at eNB 101 and at each UE. A codebook of rank-r consists of a number of Nt×r matrices where Nt is the number of eNB transmit antennas. UE feedback includes the following identities. The rank indicator (RI) is the number of data streams recommended by the UE for downlink transmission. The precoding matrix indictor is the index of UE 109 recommended precoding matrix in the rank-r codebook. For E-UTRA LTE Rel-8, a single PMI is reported for each frequency subband, corresponding to the RI report. The channel quality indicator (CQI) is quality of the channel such as the supportable data rate or Signal to Noise Ratio (SNR) assuming the reported RI and PMI are used for downlink transmission. The reported CQI is associated with the reported PMI.

A multiuser MIMO system with Nt transmit antennas at eNB 101, Nr receive antennas per UE and K=2 UEs in the system has a received signal is given by:

y=H₁V₁s₁+H₁V₂s₂+n₁

y₂H₂V₁s₁+H₂V₂s₂+n₂ (1)

where: V₂ and V₂ are the precoding matrices for respective user 1 and user 2; s₁ and s₂ are the data vectors for respective user 1 and user 2; Hⱼ is the channel matrix from eNB 101 to the j-th user; and n₂ and n₂ are the received noise for respective user 1 and user 2. The design principle of MU-MIMO is to find precoding matrices V₂ and V₂ which minimize or completely avoid interuser interference. This is given by:

H₁V₂=0, H₂V₁=0 (2)

while achieving a good system performance for the effective single-user channel H₁V₁ and H₂V₂.

3GPP LTE Rel-9 and Rel-10 Long Term Evolution Advanced (LTE-A) recognize three types of CSI feedback. The first type is explicit direct channel feedback. In explicit direct channel feedback the direct unprocessed DL channel matrices H is reported to eNB 101. This transmission may include quantization and compression. This provides the most detailed channel information to eNB to design the DL MU-MIMO precoding. This is disadvantageous because feedback overhead is extremely high. Both I and Q components of the channel coefficient associated with each transmit-receive antenna pair must be reported.

The second type is explicit covariance matrix feedback. In explicit covariance matrix feedback mode UE 109 reports the transmit channel covariance matrix R=sum(H′,*H). The feedback can be wideband or frequency-selective. In terms of time domain granularity, long-time channel covariance matrix could be reported. Thus R is averaged over a long time duration and reported very sporadically. Alternatively the short-term channel covariance matrix can be reported where R is averaged over a few subframes.

The third type is implicit report. In an implicit report the target UE reports a recommended MIMO transmission property. This recommended MIMO transmission property may include the rank indicator, precoding matrix indicator and the CQI. The reported RI, PMI and CQI of UE k is function of the channel of UE k and independent of the other UE's channel. Since each UE does not know a priori which other UE will be co-scheduled on the same band, nor what are the precoding matrices of the other UE, the reported RI, PMI and CQI are based on a hypothesis of SU-MIMO precoding. Upon receiving the RI, PMI and CQI report from all UEs, eNB 101 will perform downlink scheduling to decide which group of UEs can be jointly scheduled. For each possible set of users to be scheduled on the same band (Ψ=(U1,U2) where U₁ and U₂ are the indices of two users), eNB 101 will derive the post-processing MU-MIMO precoding matrices which may be non-codebook based and the post-processing MU-MIMO CQI for deciding the appropriate modulation and coding scheme. Note that the resultant MU-MIMO precoding matrix and CQI are in general functions of the channels of all users in the user set Ψ. Thus these are functions of the reported (SU-MIMO) CQIs and PMIs from all the UEs. The eNB searches over all possible UE sets Ψ to find the optimum UE set that achieves the maximum downlink performance.

This invention is an enhanced MU-MIMO technique with extended implicit CSI feedback. Consider a hypothetical set of two users, user 1 and user 2. In the prior art, each UE reports only one rank-r SU-MIMO precoding vector and a single CQI value associated with the reported rank-r PMI, where r is the reported RI value. The zero-forcing beamforming (ZFBF) transformation prior to normalization is given by G=(V)(V′V+αI)⁻¹ where V=[V1,V2].

A UE reports multiple N (where N>1) single-user PMIs instead of only one SU-PMI. The first PMI may be the optimal single-user PMI that results in the optimal SU-MIMO performance. The remaining N−1 PMIs provide additional information of the channel to facilitate the beamforming transformation. A number of criteria could be used to derive the N−1 PMIs. In a first example, the N−1 PMIs have the maximum distance to the first PMI, where the distance can be Euclidean distance, Fubini-norm distance or other. In a second example, the N−1 PMIs have the minimum distance to the first PMI, where the distance can be Euclidean distance, Fubini-norm distance or other. In a third example, the N−1 PMIs have the highest or alternatively the lowest correlation to the first PMI. In a fourth example, the N−1 PMIs are the next N−1 best SU-MIMO PMIs that result in the optimal SU CQI. Thus if N is 2, the second best PMI is reported along with the first best PMI. The first best and the second best PMI may be jointly used by the eNB to interpolate the channel information and to improve the feedback accuracy. In a fifth example, the N−1 PMIs are the N−1 worst SU-MIMO PMIs that result in the smallest SNR and therefore the worst SU performance. The N−1 PMIs selected could be a combination of these examples. The UEs report N CQIs where the j-th CQI is associated with the j-th SU PMI report. Alternatively, the j-th CQI can be derived as a function of the N reported PMI where the derivation principle is commonly known at the eNB and UE. For example, if N is 2 and the first best and the second best PMI is reported, the first CQI report corresponds to the first best PMI and the second CQI report corresponds to the second best CQI. In another example, the first CQI corresponds to the first PMI, while the second CQI corresponds to a PMI which is an interpolation of the first best and the second best PMI. The reported N PMIs may correspond to different rank values, although in the most natural practice they correspond to the same rank.

The eNB operates as follows for current example of two UEs. Upon receiving UE 109 feedback of N PMI/CQIs from each UE, eNB 101 chooses a representative PMI from the set of N PMIs. The selection can be random or pre-configured. Thus eNB 101 may choose the first PMI representing the optimal SU PMI) for each UE. If the representative PMIs of the two UEs are different, then eNB 101 performs ZFBF beamforming. If the representative PMIs of two UEs are identical, eNB 101 will replace the representative PMI of one UE with another PMI in the set of N PMI reports. This replacement may be random or pre-configured. The eNB could use the second best PMI as the representative PMI and replace the first best PMI. In another example, eNB 101 can derive a PMI from the set of N reported PMIs such as by a linear/non-linear interpolation. This procedure is repeated until the representative PMIs of UEs are different from each other. Then eNB 101 performs ZFBF transformation to derive the beamforming vectors.

In a SU-MIMO system a frequency resource block (RB) is occupied by a single UE exclusively at a particular time instant. On the other hand, in a MU-MIMO system a RB can be occupied by two UEs simultaneously at a give time. In several conventional wireless communication standards such as E-UTRA LTE Rel-8, a UE is semi-statically configured in either SU or MU-MIMO mode by higher-layer Radio Resource Control (RRC) signaling. Switching between SU-MIMO and MU-MIMO modes occurs semi-statically. Thus once a UE is configured in a specific MIMO mode (SU or MU), it will remain in that mode for a long time until re-configured by a higher layer. A CSI report by UE 109 is only required to target the specific MIMO mode.

Dynamic MIMO mode switching is an important feature for advanced wireless communication system. With dynamic mode switching, switching between SU-MIMO and MU-MIMO mode can occur frequently such as on every subframe of 1 mS basis. Because UE 109 does not know a priori the exact MIMO mode, UE feedback to facilitate downlink MIMO transmission must take into account both SU-MIMO and MU-MIMO aspects in order to facilitate the dynamic switching and UE scheduling and paring. This is in contrast to semi-static mode switching where UE feedback can assume either a SU or MU hypothesis.

A related disclosure U.S. patent application Ser. No. 12/851,257 filed Aug. 5, 2010 entitled “Multiple Rank CQI Feedback for Cellular Networks” discloses proposed advanced implicit CSI feedback schemes (CQI/PMI/RI) to better support the dynamic MIMO mode switching. Relevant details of the proposal in this prior patent application are repeated below for reference.

In multi-rank CQI/PMI feedback, UE 109 reports multiple precoding vectors. Each precoding vector belongs to a different rank codebook. The UE reports CQIs for each reported PMI assuming downlink transmission using the reported PMI. The UE may report PMIs associated with rank r₁, r₂, . . . r_{L}, where: L is the number of reported ranks; and rᵢ is the RI of the i-th reported rank. A total of N=Nᵣ₁+Nᵣ₂+ . . . N_{rL} PMIs are reported, where: Nrᵢ is the number of PMI report in the rank-rᵢ codebook. Thus UE 109 reports Nr₁ rank-r₁ PMIs, Nr₂ rank-r₂ PMIs and so forth. Assuming the codebook-size for each rank is M and N PMIs are reported for each rank, the PMI feedback overhead is:

N*log ₂(M) (3)

The number of rank reports L and the range of ranks r₁, r₂, . . . r_{L} for PMI reports, can be determined by UE 109 or semi-statically configured by higher-layer signaling at eNB 101. Thus the number of reported ranks L can be determined by UE 109 or configured by eNB 101. The values of Nrᵢ can be either determined by UE 109 based on UE 109 estimation of the DL channel or configured by eNB with semi-static higher-layer signaling. In either case, the values of Nrᵢ change at a very low-rate compared to the feedback frequency of CQI/RI/PMI. When UE reports a single-rank (L=1) and a single PMI (Nr=1), UE feedback reverts to the conventional implicit CSI framework of E-UTRA LTE Rel-8.

A nested structure is an important feature for codebook design and has been adopted in E-UTRA LTE Rel-8 standard. With a nested PMI with multi-rank CQI/PMI feedback, a precoding matrix in a lower-rank codebook is a sub-matrix of the precoding matrix corresponding to the same PMI value in a higher-rank codebook. If nested structure is supported in the codebook, it is possible to reduce the PMI feedback overhead by reporting the precoding matrices of different ranks corresponding to the same PMI values. Thus a single set of Nr PMIs are reported for all the rank r₁, r₂, . . . r_{L} rather than separate/independent PMI reports for different ranks where N=Nᵣ₁+Nᵣ₂+ . . . N_{rL} PMIs are fed back. This reduces the PMI feedback overhead by L times, where L is the number of ranks configured for PMI reports. It is possible to jointly report the CQI of different ranks rather than employing separate feedback. It is also possible to only report CQIs corresponding to higher rank PMIs, while the CQI corresponding to PMIs of lower-ranks can be derived by the higher-rank CQIs by eNB 101. Thus the CQI corresponding to lower rank PMIs do not need to be reported explicitly. This nested CQI feedback structure is particularly useful when nested PMI feedback is supported.

This invention includes several improved multi-rank CQI/PMI feedback methods for DL MU-MIMO. One embodiment includes periodic multi-rank CQI/PMI feedback. In a semi-static SU-MIMO mode, implicit CSI feedback includes RI, CQI and PMI reported under the SU-MIMO hypothesis. The UE reports the preferred RI value as well as the preferred CQI/PMI based on the RI report. Implicit RI/PMI/CQI feedback is reported on the uplink channel with a feedback periodicity of N subframes. Periodic RI/CQI/PMI is supported in E-UTRA LTE Rel-8 on the Physical Uplink Control CHannel (PUSCH). Extension to Physical Uplink Shared CHannel (PUSCH) is supported in E-UTRA LTE-Advanced Rel-10. When using PUSCH, RI/CQI/PMI are reported in the same subframe. Hence, RI and CQI/PMI have the same feedback periodicity N_{RI}=N_{CQI,PMI}, where: N_{RI} is the period of the RI reporting; and N_{CQI,PMI} is the period of the CQI/PMI reporting. When using PUCCH, RI and CQI/PMI are separately encoded and reported in different subframes. Since rank changes at a slower rate than CQI/PMI in most cases, the reporting periodicity of rank can be configured M times of that of the CQI/PMI reporting periodicity. Thus N_{RI}=M*N_{CQI,PMI}, where M is a non-negative integer number. The reported rank for SU-MIMO is determined by UE 109 and is within the range of [1, min(Nₜₓ,Nᵣₓ)]. This defines the RI/CQI/PMI feedback as implicit CSI for SU-MIMO.

In a semi-static MU-MIMO mode, eNB 101 may request UE 109 to report CQI/PMI of a pre-configured set of rank(s) r₁, r₂, . . . r_{L} to support rank (r₁, r₂, . . . r_{L}) transmission to this UE in MU-MIMO as previously described. The eNB may request rank-1 CQI/PMI, or rank-2 CQI/PMI, or both rank-1 and rank-2 CQI/PMI report from UE 109. Since the rank is pre-defined by eNB 101, the rank values do not have to be explicitly reported by UE 109. This defines the CQI/PMI feedback as implicit CSI for MU-MIMO.

One shortcoming of the semi-statically configured feedback mode either SU or MU is that it limits the flexibility of dynamic SU/MU switching at eNB 101. Thus if eNB configures a UE to report rank-1 CQI/PMI for MU-MIMO, when eNB 101 decides schedule UE 109 in SU-MIMO operation it is difficult to obtain the CQI/PMI needed for SU-MIMO transmission. The following techniques facilitate dynamic SU/MU switching.

The eNB configures UE 109 to report implicit CSI for both SU-MIMO and MU-MIMO. The implicit CSI for SU-MIMO enables eNB 101 to perform link adaptation and rate prediction when UE 109 is scheduled in SU-MIMO transmission. The implicit CSI for MU-MIMO enables eNB 101 to schedule UE in MU-MIMO transmission. For example, the MU-MIMO CSI may be a rank-1 PMI/CQI which is used for MU beamforming where rank-1 transmission per UE is scheduled. The UE reports of the SU-MIMO CSI and/or the MU-MIMO CSI can be configured to be periodic on PUCCH or PUSCH, or aperiodic when triggered by an UL grant. However, it is more common to configure the SU-MIMO and MU-MIMO feedback to be periodic or aperiodic at the same time.

MU-MIMO is more suitable for low-mobility UE with favorable channel condition such as medium to high geometry. It is possible to configure the feedback periodicity of MU-MIMO CSI to be larger than that of SU-MIMO CSI. Thus SU-MIMO CSI is reported more frequently than MU-MIMO CSI. This enables faster link adaptation for SU-MIMO operation. MU-MIMO CSI needs to be reported less frequently due to the typically lower UE mobility and channel variation. The reporting periodicity of MU-MIMO CSI can be M times of that the SU-MIMO CSI periodicity, where M is an integer.

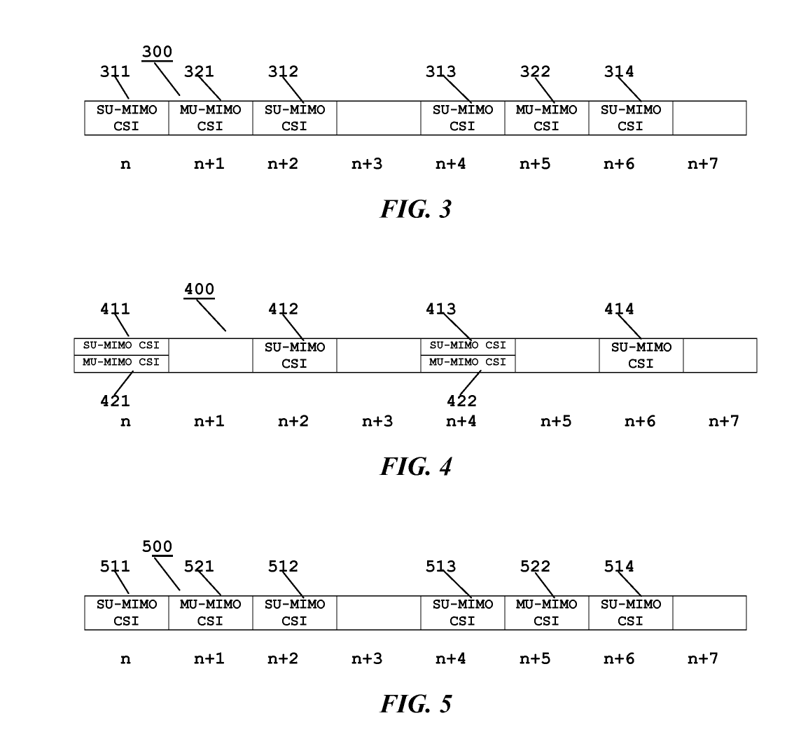

FIG. 3 illustrates an example of this technique. FIG. 3 illustrates eight subframes 300 notated n, n+1, n+2, n+3, n+4, n+5, n+6 and n+7. SU-MIMO CSI feedback is transmitted during subframes 311, 312, 313 and 314. SU-MIMO CSI feedback during subframes n, n+2, n+4 and n+6 shows a periodicity of 2. MU-MIMO CSI feedback is transmitted during subframes 321 and 322. MU-MIMO CSI feedback during subframes n+1 and n+5 shows a periodicity of 4. Thus the feedback periodicity of MU-MIMO CSI (4 subframes) is M=2 times higher than the feedback periodicity of SU-MIMO CSI (2 subframes).

When dynamic SU/MU switching is not needed, eNB 101 may turn off either the SU-MIMO CSI feedback or the MU-MIMO CSI feedback report by configuring the reporting periodicity N to infinite. Once so configured UE 109 would only report MU-MIMO CSI or SU-MIMO CSI.

The SU-MIMO CSI feedback and MU-MIMO CSI feedback can be reported in the same subframes or in different subframes. The eNB may use an offset value between the reporting instances of SU-MIMO CSI and MU-MIMO CSI to configure these settings. When reported in the same subframes, the SU-MIMO CSI and MU-MIMO CSI can be either jointly encoded and rate-matched to the same block of frequency resources or they can be separately encoded and rate-matched to different blocks of frequency resource in the feedback channel (PUCCH or PUSCH).

FIG. 4 illustrates subframes 400 in an example of when SU-MIMO CSI and MU-MIMO CSI are reported in the same subframe with different periodicities. SU-MIMO CSI feedback is transmitted during subframes 411, 412, 413 and 414. SU-MIMO CSI feedback during subframes n, n+2, n+4 and n+6 shows a periodicity of 2. MU-MIMO CSI feedback is transmitted during subframes 421 and 422. MU-MIMO CSI feedback during subframes n and n+4 shows a periodicity of 4. FIG. 4 illustrates joint feedback of SU-MIMO CSI and MU-MIMO CSI in subframes n and n+4 yields an offset N_{offset}=0.

As an alternative, it is possible to configure the SU-MIMO CSI and MU-MIMO CSI feedback in different subframes in a time-division multiplexing (TDM) manner. FIG. 5 illustrates an example of this technique. FIG. 5 illustrates eight subframes 500 notated n, n+1, n+2, n+3, n+4, n+5, n+6 and n+7. SU-MIMO CSI feedback is transmitted during subframes 511, 512, 513 and 514. SU-MIMO CSI feedback during subframes n, n+2, n+4 and n+6 shows a periodicity of 2. MU-MIMO CSI feedback is transmitted during subframes 521 and 522. MU-MIMO CSI feedback during subframes n+1 and n+5 shows a periodicity of 4. FIG. 5 illustrates joint feedback of SU-MIMO CSI and MU-MIMO CSI where the offset N_{offset}=1.

It is possible for eNB 101 to configure periodic CSI feedback for one mode of MIMO operation whereas configure aperiodic CSI feedback for another mode of MIMO operation. This may include mixes periodic and aperiodic feedback. This may be particularly beneficial when the traffic load of SU-MIMO and MU-MIMO operations are unbalanced so that eNB 101 requires different level/details of channel information for different transmission modes. For example, eNB 101 may configure the UEs for periodic SU-MIMO CSI feedback and aperiodic MU-MIMO CSI feedback. This is most useful when SU-MIMO is the more common MIMO transmission modes and the probability of a UE being scheduled in MU-MIMO is lower. These conditions would occur when the cell is lightly loaded with a small number of UEs hence the gain of enforcing users in MU-MIMO mode rather than SU-MIMO mode is limited. These conditions would also occur when most of the UEs are located in a small geographical location without sufficient spatial separation to support MU-MIMO operation. Thus most of the UEs will be highly likely to be scheduled in SU-MIMO mode and MU-MIMO transmission will be scheduled with a much lower probability. Periodic CSI feedback is configured for SU-MIMO operation to provide more detailed and up-to-date channel information to eNB 101. On the other hand, aperiodic MU-MIMO CSI can be employed on a grant-triggered basis when eNB 101 needs such information for MU-MIMO scheduling.

Alternately eNB 101 may configure the UEs for aperiodic SU-MIMO CSI feedback and periodic MU-MIMO CSI feedback. If a UE is more likely to be configured for MU-MIMO transmission than for SU-MIMO transmission, eNB 101 may configure periodic MU-MIMO CSI feedback to ensure more reliable CSI for MU-MIMO scheduling. Aperiodic SU-MIMO CSI can be triggered by grant when needed.

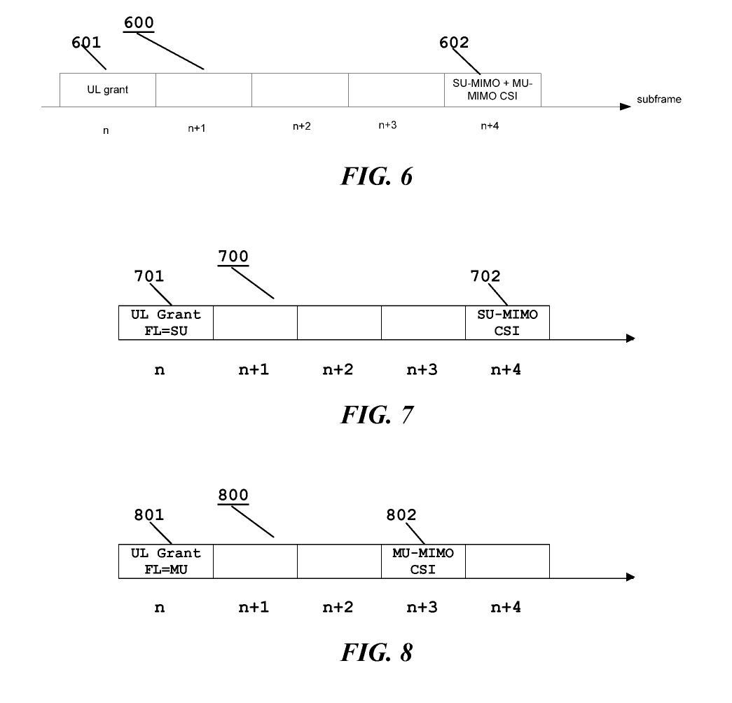

Configuration for aperiodic feedback for both SU-MIMO CSI and MU-MIMO CSI is a special case. This may be used by eNB 101 to reduce feedback overhead. In particular one UL grant can trigger both MU-MIMO CSI and SU-MIMO CSI feedback. The UE receives a single UL grant and then reports MU-MIMO CSI and SU-MIMO CSI simultaneously in the same uplink packet. FIG. 6 illustrates this situation. FIG. 6 illustrates subframes 600 n, n+1, n+2, n+3 and n+4. In subframe n eNB transmits an uplink grant signal 601 to UE 109. In subframe n+4 UE 109 transmits SU-MIMO CSI feedback and MU-MIMO CSI feedback 602 in the same subframe.

As an alternate uplink grants of different formats may be used to separately trigger report of MU-MIMO CSI feedback and SU-MIMO CSI feedback. Thus when UE 109 receives an uplink grant requesting CSI feedback of a particular type (SU or MU), it will correspondingly report the CSI of the requested type. The uplink grant signal preferably includes a 1-bit flag to distinguish the type of requested CSI feedback. FIG. 7 illustrates plural subframes 700. A UL grant signal 701 having a flag indicating SU mode occurs at subframe n. The UE responds with SU-MIMO CSI feedback 702 at subframe n+4. FIG. 8 illustrates plural subframes 800. A UL grant signal 801 having a flag indicating MU mode occurs at subframe n. The UE responds with MU-MIMO CSI feedback 802 at subframe n+3. Note the difference in length of time from the UL grant signal between FIGS. 7 and 8 is coincidental. The response time in the SU and MU modes could be equal or different.

The SU-MIMO CSI feedback and MU-MIMO CSI feedback configurations discussed above can be UE-specific or cell-specific. UE-specific configurations provide more flexibility to eNB 101 and hence is preferred.

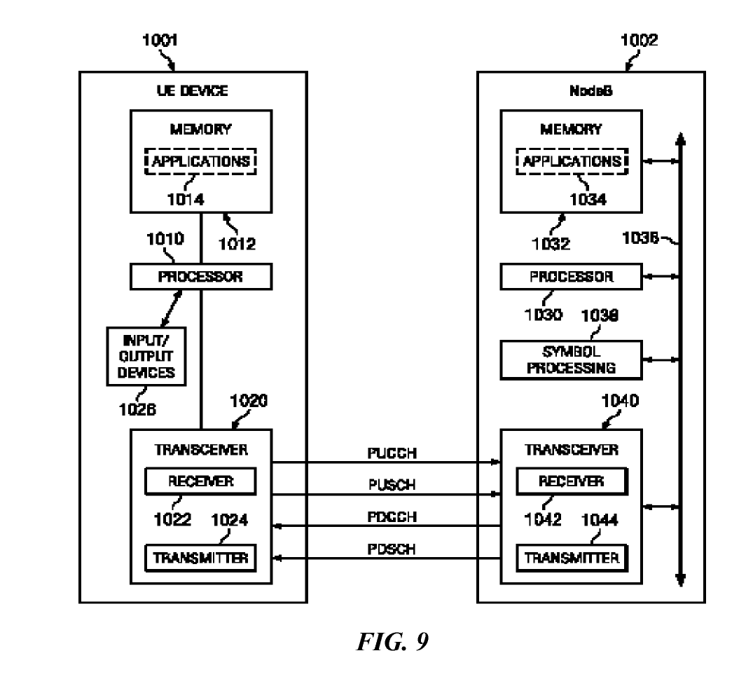

FIG. 9 is a block diagram illustrating internal details of an eNB 1002 and a mobile UE 1001 in the network system of FIG. 1. Mobile UE 1001 may represent any of a variety of devices such as a server, a desktop computer, a laptop computer, a cellular phone, a Personal Digital Assistant (PDA), a smart phone or other electronic devices. In some embodiments, the electronic mobile UE 1001 communicates with eNB 1002 based on a LTE or Evolved Universal Terrestrial Radio Access Network (E-UTRAN) protocol. Alternatively, another communication protocol now known or later developed can be used.

Mobile UE 1001 comprises a processor 1010 coupled to a memory 1012 and a transceiver 1020. The memory 1012 stores (software) applications 1014 for execution by the processor 1010. The applications could comprise any known or future application useful for individuals or organizations. These applications could be categorized as operating systems (OS), device drivers, databases, multimedia tools, presentation tools, Internet browsers, emailers, Voice-Over-Internet Protocol (VOIP) tools, file browsers, firewalls, instant messaging, finance tools, games, word processors or other categories. Regardless of the exact nature of the applications, at least some of the applications may direct the mobile UE 1001 to transmit UL signals to eNB (base-station) 1002 periodically or continuously via the transceiver 1020. In at least some embodiments, the mobile UE 1001 identifies a Quality of Service (QoS) requirement when requesting an uplink resource from eNB 1002. In some cases, the QoS requirement may be implicitly derived by eNB 1002 from the type of traffic supported by the mobile UE 1001. As an example, VOIP and gaming applications often involve low-latency uplink (UL) transmissions while High Throughput (HTP)/Hypertext Transmission Protocol (HTTP) traffic can involve high-latency uplink transmissions.

Transceiver 1020 includes uplink logic which may be implemented by execution of instructions that control the operation of the transceiver. Some of these instructions may be stored in memory 1012 and executed when needed by processor 1010. As would be understood by one of skill in the art, the components of the uplink logic may involve the physical (PHY) layer and/or the Media Access Control (MAC) layer of the transceiver 1020. Transceiver 1020 includes one or more receivers 1022 and one or more transmitters 1024.

Processor 1010 may send or receive data to various input/output devices 1026. A subscriber identity module (SIM) card stores and retrieves information used for making calls via the cellular system. A Bluetooth baseband unit may be provided for wireless connection to a microphone and headset for sending and receiving voice data. Processor 1010 may send information to a display unit for interaction with a user of mobile UE 1001 during a call process. The display may also display pictures received from the network, from a local camera, or from other sources such as a Universal Serial Bus (USB) connector. Processor 1010 may also send a video stream to the display that is received from various sources such as the cellular network via RF transceiver 1020 or the camera.

During transmission and reception of voice data or other application data, transmitter 1024 may be or become non-synchronized with its serving eNB. In this case, it sends a random access signal. As part of this procedure, it determines a preferred size for the next data transmission, referred to as a message, by using a power threshold value provided by the serving eNB, as described in more detail above. In this embodiment, the message preferred size determination is embodied by executing instructions stored in memory 1012 by processor 1010. In other embodiments, the message size determination may be embodied by a separate processor/memory unit, by a hardwired state machine, or by other types of control logic, for example.

eNB 1002 comprises a Processor 1030 coupled to a memory 1032, symbol processing circuitry 1038, and a transceiver 1040 via backplane bus 1036. The memory stores applications 1034 for execution by processor 1030. The applications could comprise any known or future application useful for managing wireless communications. At least some of the applications 1034 may direct eNB 1002 to manage transmissions to or from mobile UE 1001.

Transceiver 1040 comprises an uplink Resource Manager, which enables eNB 1002 to selectively allocate uplink Physical Uplink Shared CHannel (PUSCH) resources to mobile UE 1001. As would be understood by one of skill in the art, the components of the uplink resource manager may involve the physical (PHY) layer and/or the Media Access Control (MAC) layer of the transceiver 1040. Transceiver 1040 includes at least one receiver 1042 for receiving transmissions from various UEs within range of eNB 1002 and at least one transmitter 1044 for transmitting data and control information to the various UEs within range of eNB 1002.

The uplink resource manager executes instructions that control the operation of transceiver 1040. Some of these instructions may be located in memory 1032 and executed when needed on processor 1030. The resource manager controls the transmission resources allocated to each UE 1001 served by eNB 1002 and broadcasts control information via the PDCCH.

Symbol processing circuitry 1038 performs demodulation using known techniques. Random access signals are demodulated in symbol processing circuitry 1038.

During transmission and reception of voice data or other application data, receiver 1042 may receive a random access signal from a UE 1001. The random access signal is encoded to request a message size that is preferred by UE 1001. UE 1001 determines the preferred message size by using a message threshold provided by eNB 1002. In this embodiment, the message threshold calculation is embodied by executing instructions stored in memory 1032 by processor 1030. In other embodiments, the threshold calculation may be embodied by a separate processor/memory unit, by a hardwired state machine, or by other types of control logic, for example. Alternatively, in some networks the message threshold is a fixed value that may be stored in memory 1032, for example. In response to receiving the message size request, eNB 1002 schedules an appropriate set of resources and notifies UE 1001 with a resource grant.

What is claimed is:

1. A method of implicit channel state information (CSI) feedback for communication between a base station (eNB) and a plurality of user equipment (UE), comprising the steps of:
each user equipment reporting a plurality of single user precoding matrix indicators (PMI) including
a first PMI indicating a recommended optimum precoding matrix for single user multiple input, multiple output (SU-MIMO) communication between said base station (eNB) and said user equipment, and
at least one further PMI indicating information for beamforming at said base station; and
the base station communicating with each user equipment based on precoding matrix indicators received from the plurality of user equipment.

2. The method of claim 1, wherein:
said at least one further PMI indicates a maximum distance to the first PMI.

3. The method of claim 2, wherein:
said maximum distance is a Euclidean distance.

4. The method of claim 2, wherein:
said maximum distance is a Fubini-norm distance.

5. The method of claim 1, wherein:
said at least one further PMI indicates a minimum distance to the first PMI.

6. The method of claim 5, wherein:
said maximum distance is a Euclidean distance.

7. The method of claim 5, wherein:
said maximum distance is a Fubini-norm distance.

8. The method of claim 1, wherein:
said at least one further PMI indicates a highest correlation to the first PMI.

9. The method of claim 1, wherein:
said at least one further PMI indicates a lowest correlation to the first PMI.

10. The method of claim 1, wherein:
said at least one further PMI consist of a sequence, each PMI in the sequence indicating a next best precoding matrix for single user multiple input, multiple output (SU-MIMO) communication.

11. The method of claim 1, wherein:
the base station communicating with each user equipment based on a corresponding recommended optimum precoding matrix transmitted by the user equipment.

12. The method of claim 1, wherein:
if the recommended optimum precoding matrixes transmitted by two user equipments differ, the base station communicating to the two user equipments based on a corresponding the recommended optimum precoding matrix transmitted by each user equipment.

13. The method of claim 1, wherein:
if the recommended optimum precoding matrix transmitted by two user equipments are equal, the base station communicating to
a first user equipment based on a corresponding recommended optimum precoding matrix transmitted by the first user equipment, and
a second user equipment based on a precoding matrix indicated by the at least one further PMI of the second user equipment.

14. A method of implicit channel state information (CSI) feedback for communication between a base station (eNB) and a plurality of user equipment (UE), comprising the steps of:
each user equipment reporting
a first set of precoder matrix indicators (PMI) comprising of at least one single-user PMI applicable for single-user multiple input, multiple output (SU-MIMO) communication between said base station and said user equipment, and
a second set of precoding matrix indicators (PMI) comprising of at least one PMI applicable for multi-user multiple input multiple output (multi-user MIMO) communication between said base station and said user equipment; and
the base station communicating with each user equipment based on precoding matrix indicators received from the plurality of user equipment.

15. The method of claim 14, wherein:
said step of each user equipment reporting the first set of PMIs includes reporting on a first periodicity of subframes; and
said step of each user equipment reporting the second set of PMIs includes reporting on a second periodicity of subframes different from the first periodicity of subframes.

16. The method of claim 15, wherein:
the second periodicity is an integer times longer than the first periodicity.

17. The method of claim 15, wherein:
said step of user equipment reporting the first set of PMIs occurs in differing subframe that said step of reporting the second set of PMIs.

18. The method of claim 15, wherein:
said step of user equipment reporting the first set of PMIs occurs in a same subframe as that said step of reporting the second set of PMIs.

19. The method of claim 15, wherein:
said step of each user equipment reporting the first set of PMIs includes reporting on a first periodicity of subframes; and
said step of each user equipment reporting the second set of PMIs includes reporting in response to an uplink grant by the base station.

20. The method of claim 15, wherein:
said step of each user equipment reporting the first set of PMIs includes reporting in response to an uplink grant by the base station; and
said step of each user equipment reporting the second set of PMIs includes reporting on a first periodicity of subframes.

21. The method of claim 15, wherein:
said step of each user equipment reporting the first set of PMIs includes reporting in response to an uplink grant by the base station indicating a request for the first set of PMIs; and
said step of each user equipment reporting the second set of PMIs includes reporting in response to an uplink grant by the base station indicating a request for the second set of PMIs.
